(19) United States
(12) Patent Application Publication
(10) Pub. No.: US 2014/0307462 A1
(43) Pub. Date: Oct. 16, 2014

(54) LIGHT GUIDING ELEMENT AND BACKLIGHT MODULE USING SAME

(71) Applicant: HON HAI PRECISION INDUSTRY CO., LTD., New Taipei (TW)

(72) Inventor: LI-YING WANG HE, Tu-Cheng (TW)

(73) Assignee: HON HAI PRECISION INDUSTRY CO., LTD., New Taipei (TW)

(21) Appl. No.: 14/203,583

(22) Filed: Mar. 11, 2014

(30) Foreign Application Priority Data
Apr. 10, 2013 (TW) 102112604

(51) Int. Cl. F21V 8/00

(52) U.S. Cl. CPC G02B 6/001
USPC 362/560; 362/551; 362/559

(57) ABSTRACT

A light guiding element includes at least one fixing element and a number of light guiding pipes positioned on the fixing element. Each light guiding pipe includes a light guiding portion and a light scattering portion. The light guiding portion includes a first side surface, and a receiving recess is defined in the first side surface. A refractive index of the light guiding portion is greater than that of air. The light scattering portion includes a second side surface, and a protrusion protrudes from the second side surface. A plurality of diffusion particles are uniformly distributed in the light scattering portion. A refractive index of the light scattering portion is greater than that of air. The protrusion is received in the receiving recess.

### BACKGROUND

1. Technical Field

The present disclosure relates to light guiding elements, and particularly to a light guiding element capable of mixing light rays uniformity and a backlight module using same.

2. Description of the related art

Light guiding elements are positioned between a light source and a liquid crystal display. Light rays emitted from the light source are evenly mixed and then guided into the liquid crystal display. However, in order to improve the mixing uniformity of the light rays, the designing of the structure of the light guiding element is complex, which increases a cost of the light guiding element.

Therefore, it is desirable to provide a light guiding element and a back light module to overcome the limitations described.

### BRIEF DESCRIPTION OF THE DRAWINGS

FIG. 1 is an isometric view of a back light module in accordance with an exemplary embodiment.

FIG. 2 is an isometric view of a light guiding pipe of a light guiding element of the back light module of FIG. 1.

FIG. 3 is an isometric, exploded view of the light guiding pipe of FIG. 3.

FIG. 4 is an isometric view of a fixing element of the light guiding element of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

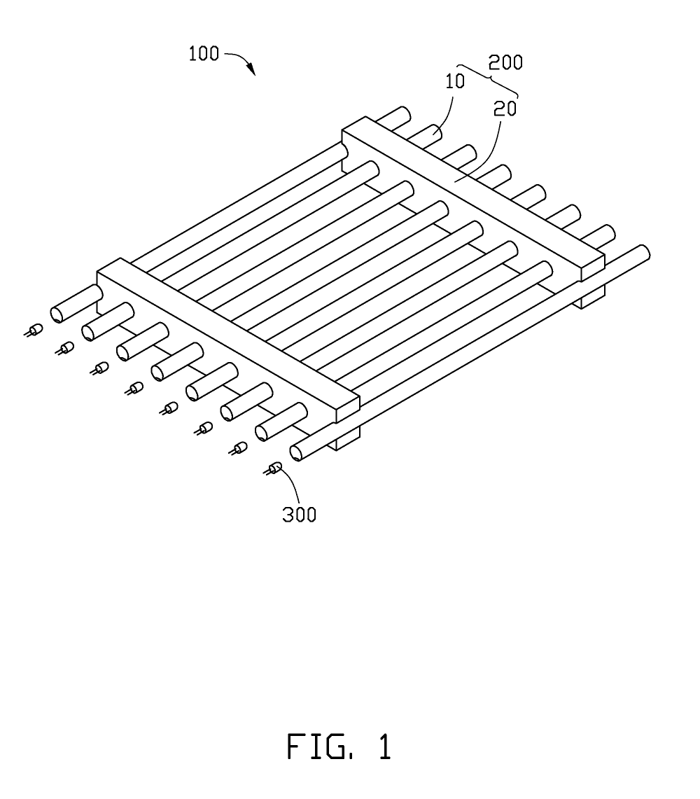

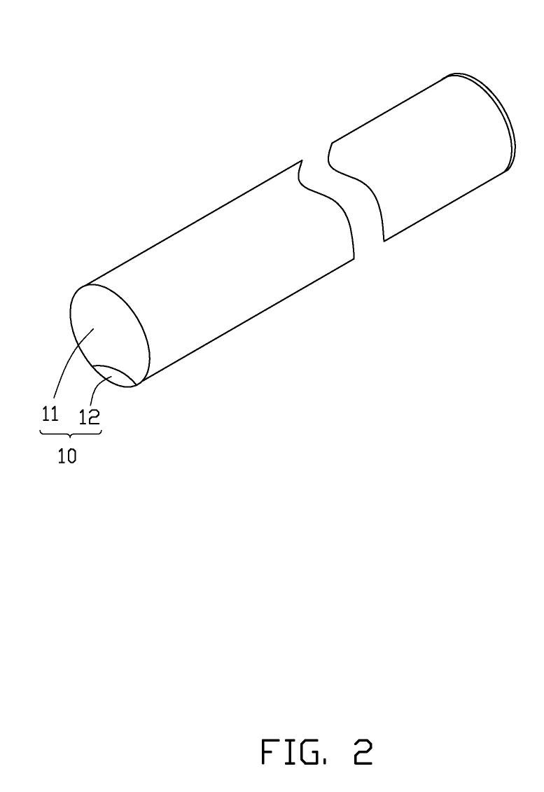

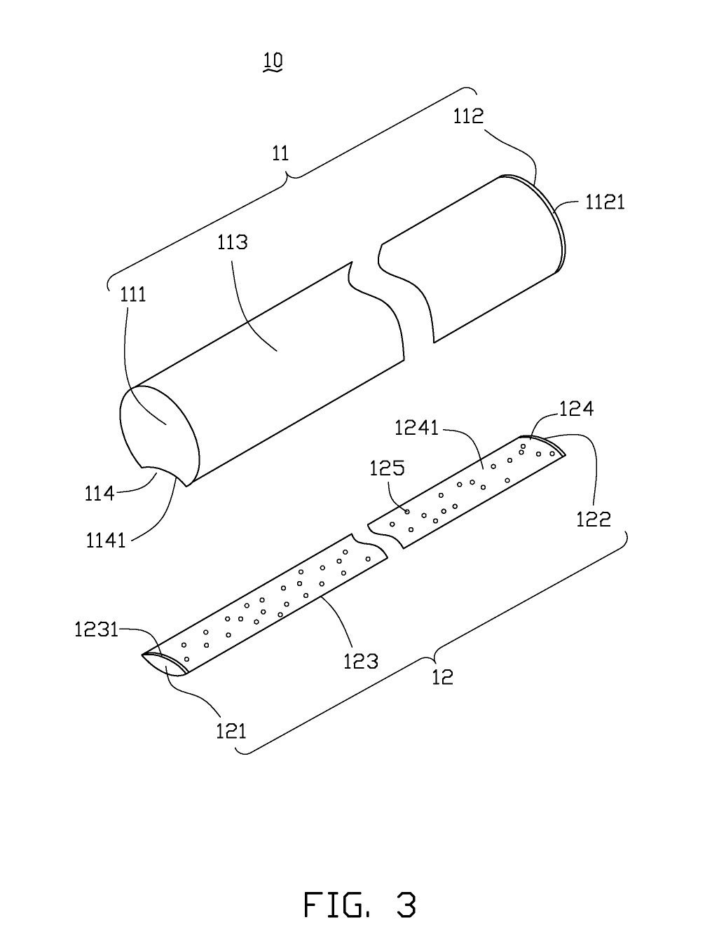

FIGS. 1-3 show an embodiment of a back light module 100, which is used in a light crystal display (not shown). The back light module 100 includes a light guiding element 200 and a number of light sources 300 emitting light rays into the light guiding element 200.

The light guiding element 200 includes a number of light guiding pipes 10 and at least one fixing element 20. Each light guiding pipe 10 is positioned on the fixing element 20.

Each light guiding pipe 10 is a strip-shaped cylinder, and includes a light guiding portion 11 and a light scattering portion 12 coupled with the light guiding portion 11.

The light guiding portion 11 is strip-shaped, and is made of polymethyl methacrylate (PMMA) or polycarbonate (PC). A refractive index of the light guiding portion 11 is greater than that of air. The light guiding portion 11 includes a first bottom surface 111, a second bottom surface 112 facing the first bottom surface 111, and a first side surface 113 connected between the first bottom surface 111 and the second bottom surface 112. A shape of the first bottom surface 111 is the same as a shape of the second bottom surface 112. A receiving recess 114 is defined in the first side surface 113, and extends from the first bottom surface 111 to the second bottom surface 112. The receiving recess 114 includes a concave surface 1141 connecting to the first side surface 113. A first reflection film 1121 is coated on the second bottom surface 112, and is used for reflecting the light rays projected on the second bottom surface 112.

The light scattering portion 12 is strip-shaped, and is made of polyethylene terephthalate (PET). A length of the light scattering portion 12 is equal to a length of the light guiding portion 11. A refractive index of the light scattering portion 12 is greater than that of the light guiding portion 11. The light scattering portion 12 includes a first end surface 121, a second end surface 122 facing the first end surface 121, and a second side surface 123 connected between the first end surface 121 and the second end surface 122. A shape of the first end surface 121 is the same shape as the second end surface 122. A protrusion 124 protrudes from a part of the second side surface 123, and extends from the first end surface 121 to the second end surface 122. The protrusion 124 includes a convex surface 1241, and couples to the receiving recess 114.

A number of diffusion particles 125 are uniformly distributed in the light scattering portion 12 including the protrusion 124. The diffusion particles 125 are made of silica, polymethyl methacrylate (PMMA), or glass. A second reflection film 1231 is coated on the on the first end surface 121, the second end surface 122, and the second side surface 123, and is used for reflecting the light rays projected on the first end surface 121, the second end surface 122, and the second side surface 123.

The protrusion 124 of the light scattering portion 12 is received in the receiving recess 114 of the light guiding portion 11. The convex surface 1241 contacts with the concave surface 1141. The first side surface 113 and the second side surface 123 form a cylindrical surface of the light guiding pipe 10. The first bottom surface 111 and the first end surface 121 form a round surface of the light guiding pipe 10. The second bottom surface 112 and the second end surface 122 form a round surface of the light guiding pipe 10. The light scattering portion 12 connects with the light guiding portion 11 via an optical glue (not shown).

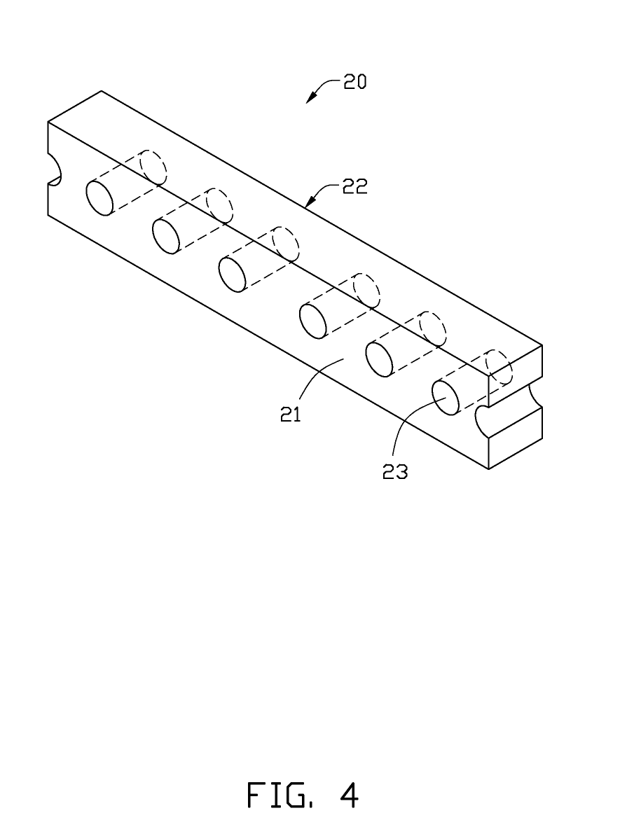

Referring to FIG. 4, the at lease one fixing element 20 is a cuboid, and is made of plastic or metal. The fixing element 20 includes a front side surface 21 and a rear side surface 22 facing the front side surface 21. The fixing element 20 defines a number of positioning holes 23 penetrating the front side surface 21 and the rear side surface 22. The positioning holes 23 are arranged at equal-intervals on the fixing element 20 from one end to an opposite end. The internal diameter of the positioning holes 23 is slightly greater than an external diameter of the light guiding pipe 10.

In the embodiment, the light guiding element 200 includes two fixing elements 20. One end of each light guiding pipe 10 is received in the positioning hole 23 of one fixing element 20, and another end of the each light guiding pipe 10 is the positioning hole 23 of another fixing element 20. The first side surfaces 113 of all of the light guiding pipes 10 face an upper end of the fixing elements 20, and the second side surfaces 123 of all of the light guiding pipes 10 face a lower end of the fixing elements 20. Cross lines (not labeled) of the first side surface 113 and the second side surface 123 are coplanar.

The fixing element 20 can be designed to other shapes, such as plate-shaped. The fixing element 20 defines a number of positioning recesses for positioning the light guiding pipe 10.

The light sources 300 are light emitting diodes (LEDs), and a row of light sources 300 are positioned on a side of the light guiding element 200 adjacent to the first bottom surface 111 of the light guiding portion 11. The light sources 300 respectively face the first bottom surfaces 111. The light rays emitted from the light sources 300 are projected into the light guiding pipes 10 from the first bottom surface 111. An incident angle of each light rays projected into the light guiding pipes 10 is greater than a critical angle of a total reflection.

In use, after the light rays enter into the light guiding pipes 10, a part of the light rays projects on the first side surface 113 and another part of the light rays projects on the concave surface 1141. As the reflection index of the light guiding portion 11 is greater than air and the incident angle of the light rays projected on the first side surface 113 is greater than the critical angle, the light rays projected on the first side surface 113 will be totally reflected. Therefore, part of light rays will not emit from the first side surface 113. The light rays reflected by the first side surface 113 project on the second bottom surface 112 and the concave surface 1141. The light rays projected on the second bottom surface 112 are reflected to the first side surface 113 and the concave surface 1141 by the first reflection film 1121. As the refractive index of the light scattering portion 12 is greater than that of the light guiding portion 11, the light rays projected on the concave surface 1141 will not be totally reflected, a part of the light rays will be refracted into the light scattering portion 12 from the convex surface 1241 and another part of the light rays will be reflected in the light guiding portion 11.

The light rays entering into the light scattering portion 12 are diffused by the diffusion particles 125 and are reflected by the second reflection film 1231. The light rays diffused by the diffusion particles 125 and reflected by the second reflection film 1231 will be projected on the convex surface 1241. A part of the light rays projected on the convex surface 1241 will be refracted into the light guiding portion 11, and another part of the light rays will be reflected in the light scattering portion 12. If the incident angle of the light rays projected on the first side surface 113 is less than the critical angle, the light rays will emit from the first side surface 113. If the incident angle of the light rays projected on the first side surface 113 is greater than the critical angle. The light rays are reflected in the light guiding pipe 10 as the incident angle of the light rays projected on the first side surface 113 is less than the critical angle.

In order to improve a luminance of the light sources 300, two rows of light sources 300 are respectively positioned at two ends of the light guiding pipe 10, and respectively face the first bottom surfaces 111 and the second bottom surface 112. The second bottom surface 112 is not coated the first reflection film 1121.

The reflection index of the light scattering portion 12 can be designed greater than the reflection index of air and less than the reflection index of the light guiding portion 11. The light rays projected into the light guiding portion 11 always will be reflected into the light scattering portion 12. The light scattering portion 12 diffuses the light rays before emitting from the first side surface 113.

Particular embodiments are shown and are described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A light guiding element, comprising:
at least one fixing element;
a plurality of light guiding pipes positioned on the at least one fixing element, each light guiding pipe comprising:
a light guiding portion comprising a first side surface and a receiving recess defined in the first side surface; a refractive index of the light guiding portion being greater than a refractive index of air; and
a light scattering portion comprising a second side surface and a protrusion protruding from the second side surface; a plurality of diffusion particles uniformly distributed in the light scattering portion; a refractive index of the light scattering portion being greater than the refractive index of air; the protrusion received in the receiving recess.

2. The light guiding element of claim 1, wherein the light guiding portion comprises a first bottom surface and a second bottom surface facing the first bottom surface, the first side surface is connected between the first bottom surface and the second bottom surface, the receiving recess extends from the first bottom surface to the second bottom surface.

3. The light guiding element of claim 2, wherein the light guiding portion comprises a first reflection film coated on the second bottom surface.

4. The light guiding element of claim 1, wherein the light scattering portion comprises a first end surface and a second end surface facing the first end surface, the second side surface is connected between the first end surface and the second end surface, the protrusion extends from the first end surface to the second end surface.

5. The light guiding element of claim 4, wherein the light scattering portion comprises a second reflection film coated on the first end surface, the second end surface, and the second side surface.

6. The light guiding element of claim 1, wherein the refractive index of the light scattering portion is greater than the refractive index of the light guiding portion.

7. A back light module, comprising:
a light guiding element, comprising:
at least one fixing element;
a plurality of light guiding pipes positioned on the at least one fixing element, each light guiding pipe comprising:
a light guiding portion comprising a first side surface and a receiving recess defined in the first side surface; a refractive index of the light guiding portion being greater than a refractive index of air; and
a light scattering portion comprising a second side surface and a protrusion protruding from the second side surface; a plurality of diffusion particles uniformly distributed in the light scattering portion; a refractive index of the light scattering portion being greater than the refractive index of air; the protrusion received in the receiving recess; and
a plurality of light sources each facing one end of the light guiding portion of each light guiding pipe.

8. The back light module of claim 7, wherein the light guiding portion comprises a first bottom surface and a second bottom surface facing the first bottom surface, the first side surface is connected between the first bottom surface and the second bottom surface, the receiving recess extends from the first bottom surface to the second bottom surface.

9. The back light module of claim 8, wherein the light guiding portion comprises a first reflection film coated on the second bottom surface.

10. The back light module of claim 7, wherein the light scattering portion comprises a first end surface and a second end surface facing the first end surface, the second side surface is connected between the first end surface and the second end surface, the protrusion extends from the first end surface to the second end surface.

11. The back light module of claim 10, wherein the light scattering portion comprises a second reflection film coated on the first end surface, the second end surface, and the second side surface.

12. The back light module of claim 7, wherein the refractive index of the light scattering portion is greater than the refractive index of the light guiding portion.
